(19) United States
(12) Patent Application Publication
(10) Pub. No.: US 2009/0228162 A1
(43) Pub. Date: Sep. 10, 2009

(54) Capsize prevention system for power vessels

(76) Inventor: Leopoldo Sanchez, Miami, FL (US)

Correspondence Address: JOHN H. FARO, ESQ., 1581 BRICKELL AVENUE - SUITE 2004, MIAMI, FL, 33129, US

(21) Appl. No.: 12/074,655

(22) Filed: Mar. 5, 2008

(51) Int. Cl. G06F 17/00

(52) U.S. Cl. 701/21

(57) ABSTRACT

An anti-capsizing system for automatic deployment of an auxiliary floatation device, on shallow draft marine vessels, is provided by this invention. More specifically, the system of this invention provides for automatically deploying an auxiliary floatation device, which can also restrain an occupant within such vessel under knock down conditions. Such auxiliary floatation device is further detachable from the vessel to provide personal floatation device accommodation for vessel occupants and/or a life raft accommodation for vessel occupants.

### BACKGROUND OF THE INVENTION

1. Field of the Invention

This invention relates to a device for water craft. More specifically, this invention relates to an auxiliary floatation device for deployment in the event of potential water craft capsizing. This device is designed for use in shallow draft power boat with both a planning hull and an observation tower equipped with a helm station.

2. Description of the Prior Art

The addition of an anti-capsize system to water craft to lessen the capsize tendency of maritime vessels, has been known and appreciated for some time.

These systems have been primarily designed for use on sailing vessels (“keel boats”) and catamarans (“multi-hull” vessels). In the ease of vessels of the type designed with full displacement hulls (e.g. sailboats), the anti-capsize systems typically includes a floatation device positioned at, or near the top of the sailboat mast, which can be inflated in response to an adverse attitude or capsizing moment of the vessel. As the adverse attitude of the vessel approaches “knock down” (the spreaders on the mast are close to touching the water, ˜90° from the horizontal plane of the vessel), the anti-capsize system is energized by inflation of a float located at or near the top of the mast. U.S. Pat. No. 5,255,624 (to Legare, issued Oct. 26, 1993) is representative of anti-capsize system designed for sail boats. Because most sail boats also have a keel, or ballast, below the water line, the “self-righting moment”, or the natural tendency of these vessels to remain upright, offsets the tendency of these vessels to roll or capsize. Thus, the anti-capsize system for such sail or keel boats is generally of limited size and capacity because of the lesser tendency of such vessels to roll; and the positioning of the inflatable float at or near the lop of the mast, provides a substantial mechanical advantage to the inflatable float of the anti-capsizing system, relative size of the keel boat.

The second category of anti-capsizing system is the one that has been designed for multi-hulled vessels sailing vessels, the so-called sailing “catamarans”. Because of the inherent nature of these multi-hull vessels, (e.g. shallow draft, semi-displacement hulls) they are “apparently” more stable than a keel boat (sailboat), except in a rough sea state, when one of the hulls (e.g. outriggers) lifts off the surface of the water. At that juncture, the inherent instability of the catamaran becomes manifestly apparent, because it lacks the righting moment of a keel boat (virtually no ballast below the water line). Thus, once such multi-hulled vessels, begins to roll at an excessive heel angle, there in no mechanical force to counter the capsizing moment, and the vessel will continue to roll until it capsizes. More significantly, the catamaran will remain inverted in a capsized configuration. In order to counter this vulnerability of multi-hulled vessels to roll and capsize, a number of devices have been proposed to offset the capsizing moment of such multi-hull vessels; and, alternatively, to prevent such multi-hull vessels from rolling into an inverted position. U.S. Pat. No. 4,541,356 (to Jones, issued Sep. 17, 1985) is representative of an anti-capsize system designed for use on multi-hull sailing vessels. In the Jones systems, a series of tubes located in the multi-hulls outriggers are filled with water to increase the ballast below the water line, and thereby increase the self-righting moment of such vessels. Notwithstanding that such multi-hull sailing vessels also have a mast, the system described by Legare for keel boats (U.S. Pat. No. 5,255,624) is not effective in arresting the roll of such multi-hulls this configuration because of the relative location of the mast step in the multi-hull relative to the side rail of such vessels, and the lack of the substantial ballast of a keel boat.

As above noted, the primary emphasis in the design of anti-capsizing systems has focused primarily upon sailing vessels, because of the relative vulnerability of such vessels to an adverse sea state. More specifically, sailing vessels generally lack the capacity to “power” through rough waters and, therefore, are more vulnerable to capsizing conditions. Notwithstanding, power boats are also vulnerable to capsizing conditions, particularly where they travelling at slow speeds (trawling) and/or at rest on the water way. Generally, such power boats fall into two broad categories: motor vessels having semi-displacement hulls, and motor vessels with planning hulls. This latter category of power boat has virtually no keel, minimal draft and, unlike a catamaran, lacks the inherent stability of multiple outriggers. Typically of such power vessel is the so-called “center console” style of power boat, which can be, and is usually equipped with an observation tower, to provide for an elevated view of potential fish activity in the water way. Such towers further raise the center of gravity of this category of power boat, particularly where one of more vessel occupants is perched at or near the top of such tower, thereby rendering the vessel substantially more “tender”; and, thus, more vulnerable to being capsized by unexpected wave action (wakes) from larger boats, commonly encountered while fishing in relatively calm waters. As is also readily appreciated, these motor vessels can be capsized relatively easily because there is no counter force (righting moment) to offset the roll from an unexpected wave or wake from a passing vessel. Because of their planning hull design, the type of anti-capsizing system disclosed in the Jones patent, referenced above, would be unacceptable for this type of vessel. Similarly, the anti-capsizing system disclosed in the Legare patent, referenced above, would not be effective for a vessel equipped with a planning hull because of the absence of any keel or ballast. Accordingly, there continues to exist a need to provide an effective and yet affordable means to improve the anti-capsizing tendency of power boats, and more particularly power boats with a planning hull.

### OBJECTS OF THE INVENTION

It is the object of this invention to remedy the above as well as related deficiency in the prior art.

More specifically, it is the principle object of this invention to provide an anti-capsizing system for motor vessels, specifically, shallow draft motor vessels having a planning hull.

It is another object of this invention to provide an anti-capsizing system for motor vessels with a relative high center of gravity.

It is yet another object of this invention to provide an anti-capsizing system for motor vessels, which is integral with the structure of the vessel.

It is still yet another object of this invention to provide an anti-capsizing system for motor vessels, which can be retrofitted to the structure of the vessel.

Additional objects of this invention include improved integration of the anti-capsizing system of this invention with navigational instruments to better anticipate potential capsizing events.

### SUMMARY OF THE INVENTION

The above and related objects are achieved by providing a system which includes a vessel attitude sensing device, means for communication of information, relative to vessel altitude, from such sensing device, to a data processing terminal, means for comparison of vessel attitude with a stability profile for the vessel stored in said terminal and means for energizing an anti-capsizing module on said vessel by said terminal, in accordance with said vessel attitude stability profile. The anti-capsizing module of this system includes an “air bag” like device which automatically deploys a floatation device in response to a signal from the terminal. The air-bag module is preferably affixed to a location on the vessel where a deployed auxiliary floatation device can best provide an effective counter force to the rolling moment of the vessel. In the preferred embodiments of this invention, the air bag module is affixed at near the top of an observation tower.

In one the preferred designs of the air bag module, the deployed floatation device at least partially surrounds an occupant perch of the observation tower, to prevent occupant ejection into the water upon knock down of the vessel by a wave or other sea state condition. In another the preferred embodiments of this invention, air bag module can also subsequently separate itself from the vessel to provide a life saving floatation device (raft), in the event the vessel is swamped and begins to sink. The size and shape of the deployed floatation device can vary with vessel configuration. In one the more preferred embodiments of this invention, the air bag module includes a plurality floatation devices that can be deployed either concurrently, or in some programmed sequence, depending upon the attitude of the vessel and sea state condition at the time of knock down.

### BRIEF DESCRIPTION OF DRAWINGS

FIG. 1 depicts a block diagram of the interaction of the various system component of the anti-capsizing system of this invention.

FIG. 2 depicts a center console power boat, from a port side perspective, equipped with an observation tower.

FIG. 3 depicts an enlarge view, from an astern perspective, of an observation tower of the vessel of FIG. 2, having an air bag module, prior to activation anti-capsizing module, and the deployment of a floatation device.

FIG. 4 depicts an enlarged view, from an astern perspective, of an observation tower of the vessel of FIG. 2, after the anti-capsizing module has been activated and the floatation device deployed.

### DESCRIPTION OF THE INVENTION INCLUDING PREFERRED EMBODIMENTS

The system of this invention includes three major components: a transducer or an ensemble of transducers for sensing vessel attitude (e.g. roll and yaw); an information processing ensemble (computer) for receiving, in real-time, vessel attitude information and comparing such information to a attitude stability profile for the vessel equiped with this system; and, a floatation module, in communication with the information processing ensemble, that can respond to an event signal and deploy/inflate one or more inflatable bladders within such module.

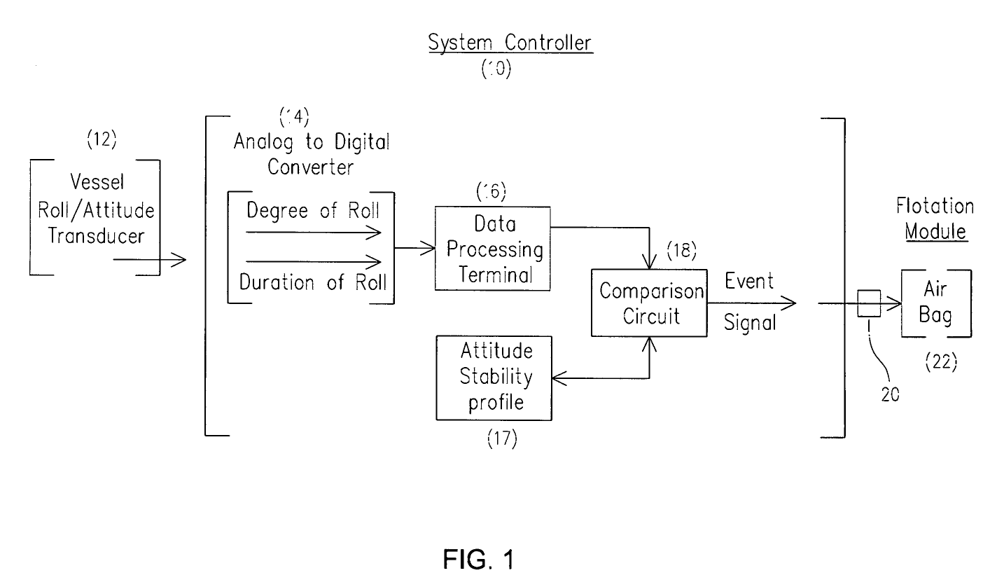

FIG. 1 depicts a block diagram of a typical anti-capsizing system of this invention. The vessel attitude transducer (12) is placed at a location on the vessel which is representative of the vessel attitude. In the preferred embodiments of this invention, the vessel attitude transducer (12) is placed on the observation tower (34), and most preferably placed at the top of the tower, in line with the center line of the vessel. The transducers (12) typically used in this environment generate an analog signal which must first be converted to digital information for processing by a computer. Accordingly, in a typical system of this invention, the information processing ensemble includes an analog to digital converter (14), a data storage capability (16), stored information, in the nature of a vessel stability profile for this vessel (17), and a comparator circuit (18) or software routine for comparing the transducer generated data with the vessel stability profile (17). In the preferred embodiments of this invention, this comparison involves not only the degree of row or yaw, but also the duration of such attitude change and the recovery of the vessel from such attitude. The vessel stability profile (17) is capable of determining if the vessel can recover from these attitude changes, and projects both a recovery and a likelihood of capsizing. In the latter situation, the information processing ensemble will automatically trigger the floatation module and automatically deploy one or more floatation devices.

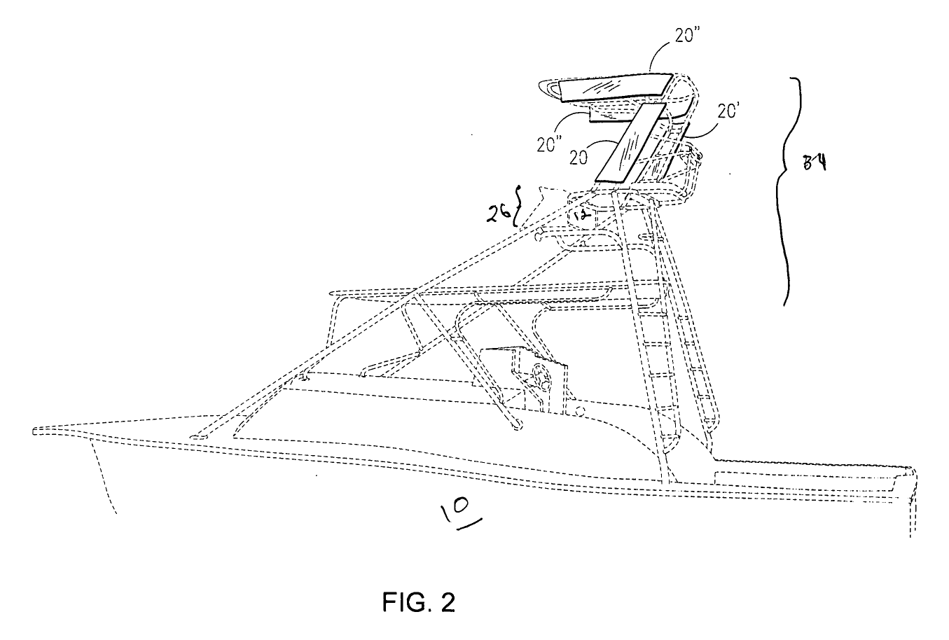

FIG. 2 depicts a shallow draft, center console motor vessel (10) having a lower control station (22), an observation tower (24) with an upper control station (26). The lower control station (22) is located at the center console of the vessel. The upper control station (26) has a control panel (28), a seat (30) and a bimini top (32) covering the observation lower (34).

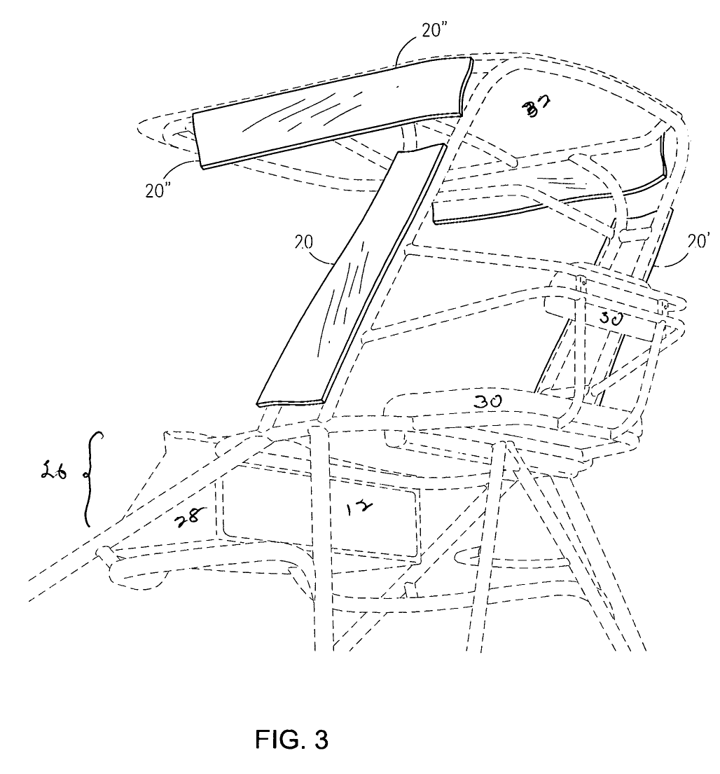

FIGS. 3 & 4 depict an enlarged view of the upper control station (26) when viewed from the stern of the vessel. In FIGS. 3 & 4, the anticapsizing module (20, 20′, 20″, 20′″) consists of a plurality of inflatable devices enclosed therein and positioned at various locations within, around and above the upper control station (26), which can be deployed all at once, or sequentially by the system controller, and/or manually. In one of the preferred embodiments of the invention depicted in FIGS. 3 & 4, the upper control station (26) is basically a cage form from tubing, with little, if any, protection of the occupants from being ejected therefrom in the event of a severe heeling of the vessel. This invention provides the means to both protect these occupants and prevent capsizing of the vessel by the automatice deployment of a series of floatation devices when the stability of the vessel is threatened.

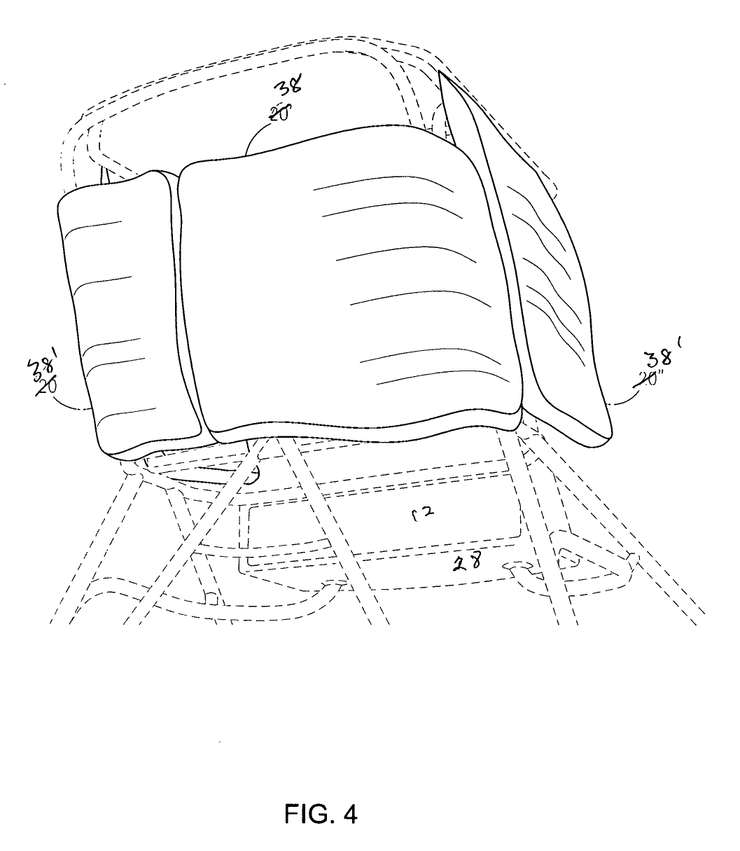

As depicted in FIGS. 3 & 4, air-bag modules (20, 20′) are preferably affixed to either side of the observation tower (34), and a second set of air bag modules (20″, 2′″), on the underside of the bimini top (32) above the upper control station. Thus as depicted in FIG. 4, upon deployment, an array of floatation devices (38, 38′) completely encircle an occupant within the observation tower. The foregoing placement of the air-bag module (20, 20′, 20″, 20′″), at the highest point above the deck, can best provide an effective counter force to the rolling moment of the vessel. These floatation device (38, 38′) in the perch on the observation tower in the upper control station (26), can also, upon detachment from the tower, provides a life raft-like floatation device.

Alternative embodiments of this invention include the installation of multiple air bag modules at different locations on a given vessel; and, the deployment of multiple floatation devices from a single air bag.

In one of the preferred alternative embodiments of this invention, an air bag module can be placed at or near the bow of the vessel and used to automatically deploy a floatation device and/or sea anchor (parachute) in response to sea state conditions: and/or, upon the manual activation thereof by the crew.

While the preferred embodiments of this invention have been depicted with respect to anti-capsizing systems for shallow draft vessels having a planning hull, the invention also has potential for adaptation to self contained life raft deployment systems in larger vessels, as well as other marine applications, where the automatic activation of a floatation device may prove useful, (e.g. “man overboard” rescue system).

What is claimed is:

1. A anti-capsizing system for the use on shallow draft marine vessels comprising:
a. A vessel attitude sensing device for detection of relative roll and roll recovery attitudes of a marine vessel, and communication thereof, in the form of machine readable data, to a data processing terminal;
b. A means for communicating of said roll and recovery attitude data of said marine vessel to a data processing terminal;
c. A data processing terminal for comparing of said roll and recovery data with a stability profile for said vessel, which has been stored in said terminal, and for generating a capsizing event signal;
d. Means for communicating said capsizing event signal to at least one anti-capsizing module located on said vessel; and
e. Means for deploying of a floatation device from said anti-capsizing module in response to said capsizing event signal.

2. The system of claim 1, wherein said shallow draft marine vessel is equipped with an observation tower having an occupant perch at or near the top of said tower.

3. The system of claim 2, wherein said anti-capsizing module comprises and air bag-like deployment mechanism, for automatically deploying and inflating a floatation device in response to said capsizing event signal.

4. The system of claim 2, wherein said anti-capsizing module comprise an air bag-like deployment system for automatically deploying and inflating a floatation device in response to a capsizing event signal, said floatation device substantially encircling said occupant perch on said observation tower, so as to restrain an occupant within said perch.

5. The system of claim 2, wherein said anti-capsizing module automatically deploys and inflates multiple floatation devices in response to a capsizing event signal.

6. The system of claim 2, wherein said capsizing event signal activates multiple anti-capsizing modules located on said marine vessel, for automatically and simultaneously deploying multiple floatation devices on said marine vessel.

7. The system of claim 2, wherein said floatation device is detachable from said anti-capsizing module.

8. The system of claim 7, wherein said detachable floatation device is in the form of a personal floatation device.

9. The system of claim 7, wherein said detachable floatation device is in the form of a life raft.

10. The system of claim 2, wherein floatation device can also be deployed by manual activation of said anti-capsizing module.
